(19) United States
(12) Patent Application Publication
(10) Pub. No.: US 2010/0039646 A1
(43) Pub. Date: Feb. 18, 2010

(54) POLARIMETRIC IMAGING SYSTEM HAVING A MATRIX OF PROGRAMMABLE WAVEPLATES BASED ON A MATERIAL WITH AN ISOTROPIC ELECTROOPTIC TENSOR

(75) Inventors: Jerome Bourderionnet, Chaville (FR); Daniel Dolfi, Orsay (FR); Sebastien Breugnot, Venice, CA (US)

Correspondence Address: LOWE HAUPTMAN HAM & BERNER, LLP, 1700 DIAGONAL ROAD, SUITE 300, ALEXANDRIA, VA, 22314, US

(73) Assignee: Thales, Neuilly/Sur/Seine (FR)

(21) Appl. No.: 12/445,991

(22) PCT Filed: Oct. 16, 2007
(86) PCT No.: PCT/EP07/61014

§ 371 Date: May 6, 2009

(30) Foreign Application Priority Data
Oct. 20, 2006 (FR) 06 09230

(51) Int. Cl. G01J 4/04

(52) U.S. Cl. 356/367

(57) ABSTRACT

The subject of the invention is a polarimetric imaging system exhibiting an optical axis, and comprising means (35) for the detection and analysis of the light backscattered by an object illuminated by a light source and at least one programmable waveplate (33), wherein the programmable waveplate comprises a material with an isotropic electrooptic tensor and a set of at least three electrodes disposed along the directions parallel to the optical axis of the imaging system.

### CROSS-REFERENCE TO RELATED APPLICATIONS

The present application is based on International Application No. PCT/EP2007/061014, filed on Oct. 16, 2007, which in turn corresponds to French Application No. 06 09230 filed on Oct. 20, 2006, and priority is hereby claimed under 35 USC §119 based on these applications. Each of the applications are hereby incorporated by referenced in their entirety into the present application.

### TECHNICAL FIELD

The invention relates to a polarimetric imaging system whose function is to measure the spatial distribution of the state of polarization of the light originating from a scene illuminated under natural light (passive imaging) or by a laser beam (active imaging).

### BACKGROUND OF THE INVENTION

The main component of the polarimetric imaging system of the invention is a programmable means for analyzing an incident polarization distribution. Such a system effects the projection of an incident spatial distribution of Stokes vectors onto an arbitrary Stokes vector. By successive measurements (for example from 2 to 4), the system thus yields a polarization-coded image (Stokes parameters) of the observed scene. This functionality is of great importance for a wide spectrum of applications, including decamouflage, the analysis of scenes, for example for the autonomous driving of unmanned terrestrial vehicles, or surface state analysis.

In a general manner, measurement of the state of polarization of the light backscattered by an object affords information on the one hand about the nature of this object, and makes it possible on the other hand to improve the contrast between the object and its environment when an image based on intensity alone is insufficient. The state of polarization of light is conventionally represented by a vector with 4 components, called the Stokes vector:

$$S = ( \begin{matrix}I \\ Q \\ U \\ V\end{matrix} )$$

where I is the total intensity, Q the horizontally or vertically linearly polarized component, U the component linearly polarized at 45° or at 135° with respect to the horizontal, and V the (right or left) circularly polarized component.

The various effects of the object on the state of polarization of the backscattered light are described by the Mueller matrix M associated with the object: Sₒᵤₜ=M×Sᵢₙ where Sᵢₙ is the state of polarization of the illumination source and Sₒᵤₜ the state of polarization of the backscattered light. The 16 coefficients mᵢⱼ of this 4×4 matrix depend on the intrinsic parameters of the object (roughness, nature, etc.) and the experimental context (angles of incidence and of observation, wavelength, etc.). Various architectures of polarimeters of active or passive type then exist, depending on the effect or effects that one seeks to highlight and the number of coefficients of the Mueller matrix that one wishes to measure.

FIG. 1 illustrates an exemplary active polarimeter comprising: an illumination source 14, a means 15 for controlling the state of polarization of this source Sᵢₙ, a means 12 of analysis of the state of polarization Sₒᵤₜ of the backscattered light 17 originating from an object 11 illuminated by said illumination source 14 and a detection means 13. Such a system allows the complete characterization of the Mueller matrix by emitting 4 chosen states of polarization, and by measuring the associated Stokes parameters (Configuration 1: 16 measurements for 16 coefficients). Moreover, it has been shown (S. Breugnot, P. Clémenceau, “Modeling and performances of a polarization active imager at λ=806 nm”, Optical Engineering, Vol. 39, No. 10, 2681-2688, October 2000) that when the directions of incidence and of observation are substantially identical (“mono-static” architecture), and for common objects, the Mueller matrix can be considered to be diagonal, with coefficients m₀₀, m₁₁, m₂₂ and m₃₃, m₁₁, being the degree of horizontal linear polarization, m₂₂ the degree of linear polarization at 45°, and m₃₃ the degree of circular polarization. The total degree of polarization is in this case defined by (m₁₁+m₂₂+m₃₃)/3m₀₀. Depending on the number of these parameters that one wishes to measure, 2, 3 or 4 measurements may be required.

With a passive polarimeter as illustrated in FIG. 2, the illumination source is totally depolarized ambient light 25 (Sᵢₙ=(I, 0, 0, 0)). The system then comprises: a means 22 of analysis of the backscattered light 24 originating from an object 21, and a detection means 23. By measuring the state of polarization Sₒᵤₜ of the backscattered light 24, the ability of the object to polarize depolarized light is measured (1^{st} column of the Mueller matrix, m₀₀, m₁₀, m₂₀ and m₃₀). For example, such a measurement will allow perfect discrimination of the water (polarizing) in a scene. m₁₀ designates the capacity to polarize according to a horizontal or vertical linear polarization, m₂₀ the capacity to polarize according to a linear polarization at 45° or 135°, and m₃₀ the capacity to polarize according to a circular polarization. Here again, depending on the number of these parameters that one wishes to measure, 2, 3 or 4 measurements will be necessary.

The various systems proposed in the state of the art differ in the means for analyzing the backscattered polarization, which can be fixed or programmable, in the number of sensors used and in the nature of the information collected, more or less directly related to the coefficients to be calculated.

With a fixed analysis means, for n measurements to be performed, it is necessary to effect n images of the scene to be characterized on n sensors, through n fixed combinations (analyzer+delay plate) or (analyzer only). The n images are obtained in various ways (combinations of prisms, holographic gratings, lenses, etc.—J. D. Barter, P. H. Y. Lee, “Visible Stokes polarimetric imager”, U.S. Pat. No. 6,122,404 (2000); M. S. Shahriar, et al, “Ultrafast holographic Stokesmeter for polarization imaging in real time”, Opt. Letters, Vol. 29, No. 3, 298-300 (2004); G. R. Gerhart, R. M. Matchko, “Simultaneous 4-Stokes parameter determination using a single digital image”, US Patent 2005/0225761 (2005)). The drawbacks of the system (complexity, bulkiness, cost, etc.) then stem from the proliferation of the imaging devices and sensors. There nevertheless exists a system which divides the image into 4 imagettes on a single sensor, but this operation is done to the detriment of the resolution and precision of the measurement (error due to the imperfection of the divider optical system, the 4 imagettes having to be strictly identical). An alternative is proposed in the literature (K. Oka, T. Kaneko, “Compact complete imaging polarimeter using birefringent wedge prisms”, Opt. Express, Vol. 11, No. 13, 1510-1519 (2003)) which uses the association of birefringent prisms followed by an analyzer to form on a single sensor an interferogram which makes it possible, after a Fourier transform calculation, to get back to the components of the incident Stokes vector. In this case, the drawback is the relative complexity of this calculation. Finally, a drawback common to all systems with fixed analysis means is that it is not possible to choose to measure only this or that component of the Stokes vector depending on their relevance.

With a programmable analysis means, the n measurements necessary for the n parameters to be measured are performed on a single sensor, but successively. A typical device (programmable waveplate and fixed analyzer) then sequentially effects the n combinations of analyses required. Conventionally, the programmable waveplate function is carried out by mechanical rotation of a waveplate or by virtue of a polarization controller based on liquid crystals (P. Clémenceau, S. Breugnot, L. Collot, “Dispositif d'imagerie par polarimétrie [Polarimetry-based imaging device]”, U.S. Pat. No. 2,769,980 (1997)). However, these pose response time problems (10 to 100 ms for nematic liquid crystals) and this may disturb the measurement in the case of variations between successive acquisitions. The response time of the component is moreover significantly large in the case where the system must be mounted on a mobile platform (drone type, with speeds of displacement of the order of 50 km/h). Specifically, the acquisition of the images must be fast so as to avoid so-called “registration” errors, that is to say movement of the scene between each image. Ferro-electric liquid crystals are faster, but do not make it possible to carry out all of the functions required. Finally, polarization controllers based on lithium niobate have a very good response time, but the low electrooptic coefficient of this material implies an integrated optics architecture, this being hardly compatible with the imaging application.

### SUMMARY OF THE INVENTION

The invention is aimed at alleviating the problems cited previously by proposing a polarimetric imaging system exhibiting an optical axis, and comprising means for the detection and analysis of the light backscattered by an object illuminated by a light source and at least one programmable waveplate, characterized in that the programmable waveplate comprises a material with an isotropic electrooptic tensor and a set of at least three electrodes disposed along the directions parallel to the optical axis of the imaging system.

According to a variant of the invention, the detection and analysis means are situated in one and the same image plane.

According to a variant of the invention, the polarimetric imaging system comprises at least one set of at least two lenses making it possible to define a first intermediate focal plane, the programmable waveplate being situated in said first focal plane.

According to a variant of the invention, the electrodes are formed of substantially cylindrical and metallized emergent holes, drilled in the thickness of the material with an isotropic electrooptic tensor.

According to a variant of the invention, the focal length f of the first lens satisfies the following equation:

$$f = \frac{\sqrt{A / π}}{{θ}_{lim}}$$

where θₗᵢₘ is the angular acceptance of the programmable waveplate and A the surface area defined by the intersection of the cone of vertex half-angle θₗᵢₘ with the plane of the first lens.

According to a variant of the invention, the polarimetric imaging system comprises at least:
a set of two matrices of micro-lenses making it possible to define a second intermediate focal plane,
a matrix of programmable waveplates, situated in said second intermediate focal plane.

According to a variant of the invention, the matrix of programmable waveplates (83) comprises a matrix of electrodes, four contact tracks so as to contact all the electrodes, a first (94) and a second (92) track being situated on a first face of the material, a third (91) and a fourth (93) track being situated on an opposite face from said first face, said electrodes exhibiting coordinates referenced by a row number j and a column number k which are integers in a reference frame corresponding to the plane of the matrix, said first track (94) linking the electrodes whose coordinates (j, k) satisfy the following equation:

k=4p₁−j, where p₁ is a relative integer,
said second track (92) linking the electrodes whose coordinates (j,k) satisfy the following equation:

k=(4p₂+2)−j, with p₂ relative integer,
said third track (91) linking the electrodes whose coordinates (j,k) satisfy the following equation:

k=(4p₃+1)+j, with p₃ relative integer,
said fourth track (93) linking the electrodes whose coordinates (j,k) satisfy the following equation:

k=(4p₄+3)+j, with p₄ relative integer.

According to a variant of the invention, the detection and analysis means comprise the measurement of the components s_{0,in}, s_{1,in}, s_{2,in} and s_{3,in} of a Stokes vector of the light backscattered by the object (31), said measurement comprising:
A series of N sets of three steps, allowing N intensity measurements, said steps being, with 1≦j≦N:
   The choice of a birefringence ∈ⱼ of the waveplate (33,53) and of an orientation θⱼ of this birefringence with respect to a predefined axis.
   The determination of the potentials Vᵢ to be applied to the electrodes Eᵢ (41, 42, 43, 44, 61, 62, 63, 64) so as to obtain the birefringence ∈ⱼ of orientation θⱼ determined in the previous step, said potentials Vᵢ satisfying the following equations:

$${V}_{i} = \frac{1}{2} \sqrt{\frac{λ {d}^{2} {ɛ}_{j}}{π {n}_{0}^{3} R e}} cos ( {θ}_{j} - i \frac{π}{2} )$$

with i an integer lying between 0 and 3, λ the wavelength, n₀ the index of the material at zero field, R the quadratic electrooptic coefficient, e the thickness of the material and d the distance between 2 facing electrodes.
The measurement of the intensity Iⱼ on the sensor.
The calculation of the values s_{0,in}, s_{1,in}, s_{2,in} and s_{3,in} on the basis of the N intensity measurements I₁, . . . , Iⱼ, . . . , I_{N}.

The advantages of the structure proposed over other programmable analysis means (opto-mechanical devices, liquid crystal based modulators) ensue from the properties of materials with isotropic electrooptic tensor and notably the electrooptic ceramics involved. Indeed, these materials have a very fast intrinsic response time (less than a microsecond), the dielectric constant of the material then giving the effective response time of the device (RC filter) of the order of a few microseconds. Moreover, these materials have a broad transmission band (transparent from 500 nm to 7000 nm (G. Haertling, C. E. Land, “Hot-pressed (Pb,La)(Zr,Ti)O3 ferroelectric ceramics for electrooptic applications”, J. Am. Ceram. Soc, 51, 1 (1971); K. K. Li, et al, “Electro-optic ceramic material and devices, PMN-PT”, U.S. patent application Ser. No. 10/139,857, May 6, 2002; K. K. Li, et al, “Electro-optic ceramic material and devices, PZN-PT”, U.S. Pat. No. 6,746,618 (2004))) with a substantially constant electrooptic coefficient. It follows from this that, unlike liquid crystal type solutions, the proposed solution covers a spectral band which extends from 500 to 7000 nm. It moreover allows better compactness, low control voltages and great flexibility in the choice of the Stokes parameters to be measured.

Still other objects and advantages of the present invention will become readily apparent to those skilled in the art from the following detailed description, wherein the preferred embodiments of the invention are shown and described, simply by way of illustration of the best mode contemplated of carrying out the invention. As will be realized, the invention is capable of other and different embodiments, and its several details are capable of modifications in various obvious aspects, all without departing from the invention. Accordingly, the drawings and description thereof are to be regarded as illustrative in nature, and not as restrictive.

### BRIEF DESCRIPTION OF THE DRAWINGS

The present invention is illustrated by way of example, and not by limitation, in the figures of the accompanying drawings, wherein elements having the same reference numeral designations represent like elements throughout and wherein:

FIG. 1 illustrates the operation of an active polarimeter according to the known art.

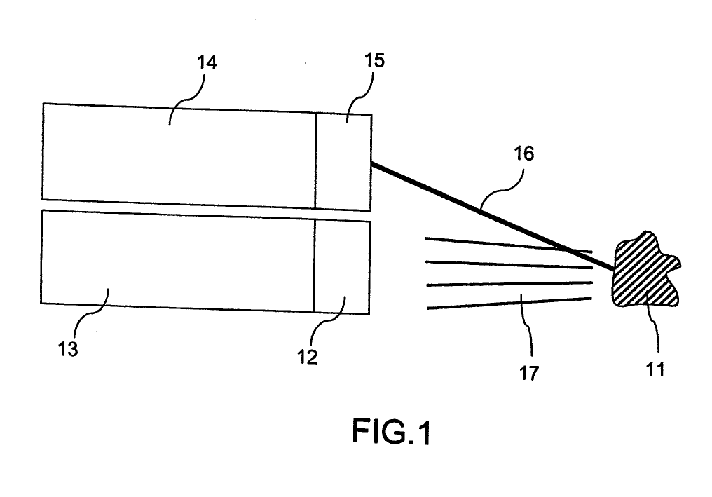

FIG. 2 illustrates the operation of a passive polarimeter according to the known art.

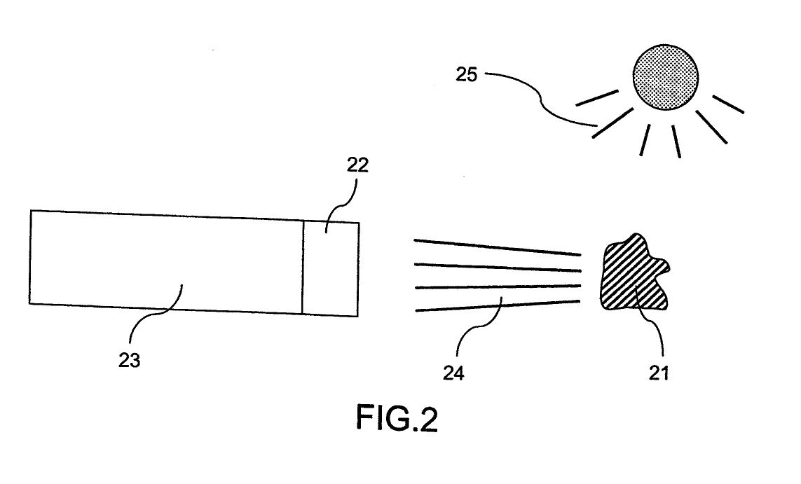

FIG. 3 illustrates a first variant of a polarimetric imaging system according to the invention.

FIG. 4 illustrates an exemplary programmable waveplate that can be used in the first variant of a polarimetric imaging system according to the invention.

FIG. 5 illustrates a second variant of a polarimetric imaging system according to the invention.

FIG. 6 illustrates an exemplary programmable waveplate that can be used in the second variant of a polarimetric imaging system according to the invention.

FIG. 7 illustrates the exemplary waveplate in the second variant of a polarimetric imaging system according to the invention, seen in section.

FIG. 8 illustrates a third variant of a polarimetric imaging system according to the invention.

FIG. 9 illustrates an exemplary matrix of programmable waveplates that can be used in the third variant of a polarimetric imaging system according to the invention.

FIG. 10 illustrates a detailed view of the matrix of programmable waveplates in the third variant of a polarimetric imaging system according to the invention.

### DETAILED DESCRIPTION OF THE INVENTION

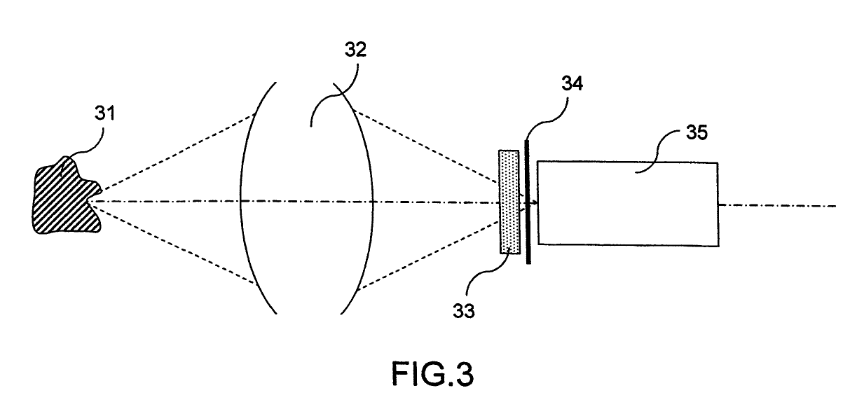

A first variant of a polarimetric imaging system according to the invention is illustrated in FIG. 3.

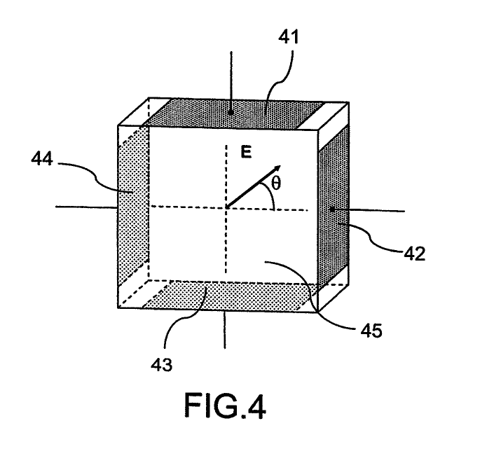

The first variant of a polarimetric imaging system according to the invention comprises an objective 32, a programmable waveplate 33, a detection means 35 and a polarizer 34 situated between said programmable waveplate and said detection means 35. The polarizer ensures the projection of the polarization according to its axis (fixed). The association of the waveplate and polarizer allows projection of the polarization along any axis. The system measures the state of polarization of the light backscattered by an object 31, illuminated by a light source. The programmable waveplate 33 comprises notably a block of a material with an isotropic electrooptic tensor, and comprising a set of at least three electrodes. An exemplary embodiment of a programmable waveplate such as this is illustrated in FIG. 4. The programmable waveplate 33 takes the form of a parallelepipedal electrooptic material block 45 on the edges of which are situated four electrodes E referenced 44, 41, 42 and 43 in FIG. 4.

The programmable waveplate 33 consists of a single pixel whose useful zone (space between the electrodes in which the applied electric field is substantially uniform) corresponds to the size of the sensor. Incident light with Stokes vector distribution Sᵢₙ(x,y) with components s_{0,in}(x,y), s_{1,in}(x,y), s_{2,in}(x,y) and s_{3,in}(x,y) is then considered. The programmable analysis function for Sᵢₙ is effected by applying the potentials Vᵢ to the electrodes Eᵢ. The potentials Vᵢ satisfy the following equation with i lying between 0 and 3:

$${V}_{i} = \frac{1}{2} \sqrt{\frac{λ {d}^{2} ɛ}{π {n}_{0}^{3} R e}} cos ( θ - i \frac{π}{2} )$$

with λ the wavelength, n₀ the index of the material at zero field, R the quadratic electrooptic coefficient, e the thickness of the material, d the distance between 2 facing electrodes. The waveplate then exhibits the birefringence ∈ along the neutral axes oriented at an angle θ with respect to the axis defined by the electrodes E₀ (44) and E₂ (42) illustrated in FIG. 4.

Its Mueller matrix is:

$${M}_{c} = \frac{1}{2} ( \begin{matrix}1 & 0 & 0 & 0 \\ 0 & {C}^{2} + {S}^{2} cos ɛ & SC ( 1 - cos ɛ ) & - S sin ɛ \\ 0 & SC ( 1 - cos ɛ ) & {S}^{2} + {C}^{2} cos ɛ & C sin ɛ \\ 0 & S sin ɛ & - C sin ɛ & cos ɛ\end{matrix} )$$

with C=cos 2θ and S=sin 2θ. The Mueller matrix of the polarizer oriented at θ=0 is:

$${M}_{p} = \frac{1}{2} ( \begin{matrix}1 & 1 & 0 & 0 \\ 1 & 1 & 0 & 0 \\ 0 & 0 & 0 & 0 \\ 0 & 0 & 0 & 0\end{matrix} )$$

The intensity measured on the sensor is I(x,y)=s_{0,out}(x,y), with Sₒᵤₜ(x,y)=Mₚ×M_{c}×Sᵢₙ(x,y), and s_{0,out}(x,y), s_{1,out}(x,y), s_{2,out}(x,y) and s_{3,out}(x,y) the components of Sₒᵤₜ(x,y). We therefore have:

$$I ( x , y ) = \frac{1}{4} ( \begin{matrix}{s}_{0 , in} ( x , y ) + ( {C}^{2} + {S}^{2} cos ɛ ) {s}_{1 , in} ( x , y ) + \\ SC ( 1 - cos ɛ ) {s}_{2 , in} ( x , y ) + S sin ɛ {s}_{3 , in} ( x , y )\end{matrix} )$$

For example, four pairs of angle and birefringence values (θ,∈) are chosen so as to obtain four similar equations forming an invertible system, and Sᵢₙ(x,y) is then completely determined. It is also possible to make only two or three measurements, depending on the number of components of Sᵢₙ that are of interest. This architecture completely fulfills the programmable analysis function, however, a pixel of the size of the sensor, corresponding to a distance of 2 centimeters between electrodes, leads to very high control voltages of the order of a few kVolts even for substrate thicknesses of 1 centimeter.

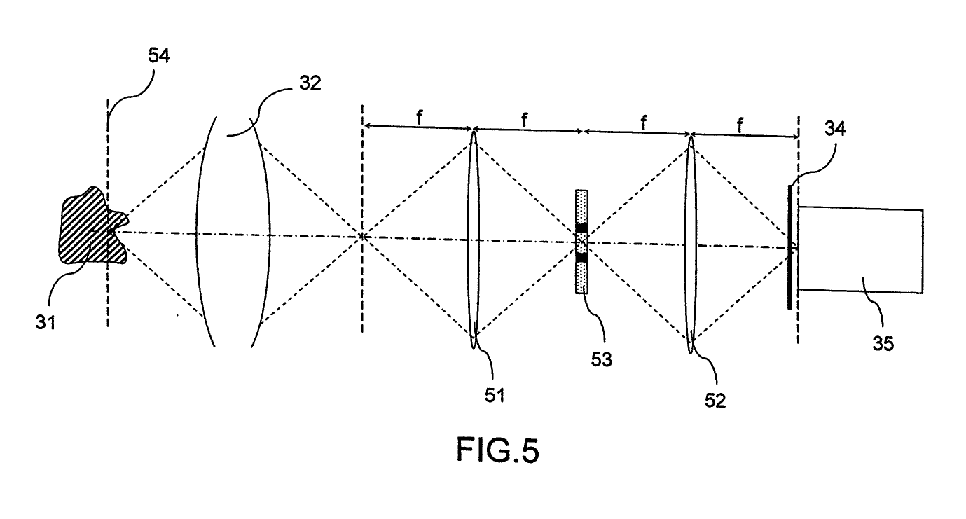

In order to reduce the control voltages, a second variant of a polarimetric imaging system according to the invention is illustrated in FIG. 5. The second variant of a polarimetric imaging system according to the invention comprises: an objective 32, a programmable waveplate 53, a detection means 35 and a polarizer 34. This system furthermore comprises two lenses 51 and 52 making it possible to define a first intermediate focal plane, the waveplate 53 being situated in this intermediate focal plane. This variant makes it possible to reduce the control voltages by reducing the size of the pixel, and by using a lens for focusing 51 in the pixel to preserve the illumination of the sensor 35.

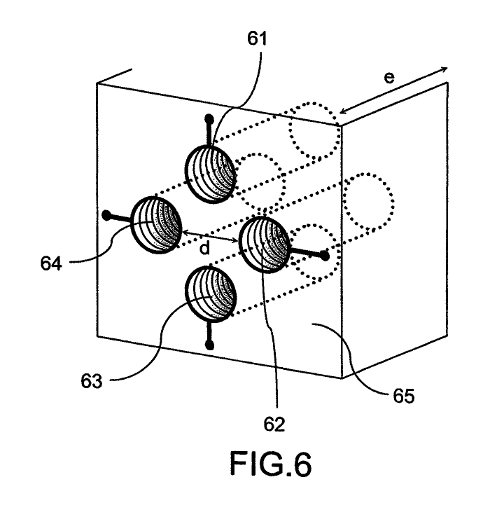

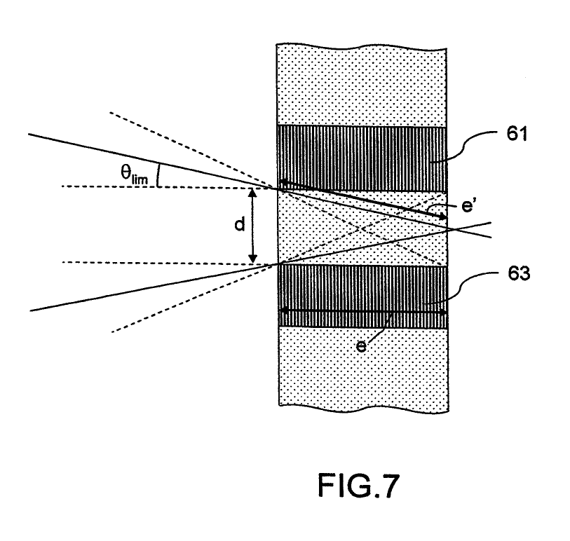

FIGS. 6 and 7 illustrate an exemplary programmable waveplate that can be used in the second variant of a polarimetric imaging system according to the invention. The programmable waveplate 53 takes the form of a parallelepipedal electrooptic material block 65 in which are drilled four holes whose walls are covered with four electrodes 61, 62, 63 and 64. The electrodes opposite one another 61 and 63 are situated a distance d apart. The same holds for the electrodes 62 and 64. The parallelepipedal electrooptic material block 65 has a thickness e.

Advantageously, the electrodes 61, 62, 63 and 64 are formed of substantially cylindrical and metallized emergent holes, drilled in the thickness of the material with an isotropic electrooptic tensor. The electrodes 61, 62, 63 and 64 are made in the volume of the material so as to optimize on the one hand the overlap between the optical wave and the applied electric field and, on the other hand, the homogeneity of the applied electric field. The effect of this is to optimize the effectiveness of the component.

In the second variant of a polarimetric imaging system according to the invention, the limiting factor is the number of resolved points of the image formed on the sensor. The programmable waveplate acts as an aperture diaphragm illustrated in FIG. 7. Specifically, the phase shift induced by the component is directly proportional to the thickness of material crossed. The angular acceptance θₗᵢₘ of the programmable waveplate must be limited to ensure a homogeneous phase shift (typically, θₗᵢₘ˜15° for a phase shift that is homogeneous to within 5%). Thus, to limit the angle of incidence of the light rays passing through the programmable waveplate, the numerical aperture of the lens for focusing on the programmable waveplate is limited. The numerical aperture ON is defined by ON=f/D, where f is the focal length of the lens and D the diameter of the lens. The maximum angle of incidence of the light rays passing through the programmable waveplate then equals atan(2/ON).

The number of resolved points in the image is then given by:

$$N = \frac{πσ {tan}^{2} {θ}_{lim}}{{λ}^{2}} \qquad ( 1 )$$

where σ is the useful area of the component (area where the applied electric field is homogeneous; in practice, σ is estimated by πd²/16), λ the wavelength and θₗᵢₘ the angular acceptance of the programmable waveplate.

According to an exemplary embodiment of the second variant of a polarimetric imaging system according to the invention, to obtain 1000×1000 resolved points in the image, the spacing d between facing electrodes must be 2.5 mm, thereby leading to control voltages of the order of 500 Volts for a substrate whose quadratic electrooptic coefficient R is typically of the order of 2.10⁻¹⁶ m²V⁻², and with a thickness e of 5 mm.

Advantageously, the focal length f of the first lens 51 satisfies the following equation:

$$f = \frac{\sqrt{A / π}}{{θ}_{lim}}$$

where θₗᵢₘ is the angular acceptance of the programmable waveplate and A the surface area defined by the intersection of the cone of vertex half-angle θₗᵢₘ with the plane of the first lens 51.

An exemplary use makes it possible to illustrate the influence of an inhomogeneity of birefringence on a measurement. Let us consider four pairs of values of (θ,∈): (0, 0), (π/4, π), (π/2, π), (π/4, π/2). The following system of equations is obtained:

I₁=¼(s_{0,in}+s_{1,in})

I₂=¼(s_{0,in}+s_{1,in})

I₃=¼(s_{0,in}+s_{2,in})

I₄=¼(s_{0,in}+s_{3,in})

which can be written in the following manner:

s_{0,in}=2(I₁+I₂)

s_{1,in}=2(I₁−I₂)

s_{2,in}=4I₃−2(I₁+I₂)

s_{3,in}=4I₄−2(I₁+I₂)

with s_{0,in}, s_{1,in}, s_{2,in} and s_{3,in} the components of the state of polarization that one seeks to measure and I₁, I₂, I₃ and I₄ the intensities measured on the sensor.

Let us consider that one seeks to measure a state of polarization Sᵢₙ=(1,0,0,1). Deviations Δ∈₁, Δ∈₂, Δ∈₃ and Δ∈₄ to the desired birefringence during the four successive measurements lead to the following measurements:

I₁=s_{0,in}/4

I₂=s_{0,in}/4

I₃=s_{0,in}/4+ sin(Δ∈₃)8*s_{3,in}

I₄=s_{0,in}/4+ cos(Δ∈₄)4*s_{3,in}

By using the previous equations, it is then deduced that:

s_{0,out}=s_{0,in}=1

s_{1,out}=0

s_{2,out}=sin(Δ∈₃)/2*s_{3,in}= sin(Δ∈₃)/2

s_{3,out}=cos(Δ∈₄)*s_{3,in}= cos(Δ∈₄)

with s_{0,out}, s_{1,out}, s_{2,out} and s_{3,out} the components of the measured state of polarization Sₒᵤₜ. If we take Δ∈₃=0.05*π and Δ∈₄=0.05*π/2 (corresponding to an inhomogeneity of 5%), we obtain: sₒᵤₜ=(1, 0, 0.078, 0.997). An error of 7.8% is noted between the real value s_{2,in} and the measured value s₂ₒᵤₜ.

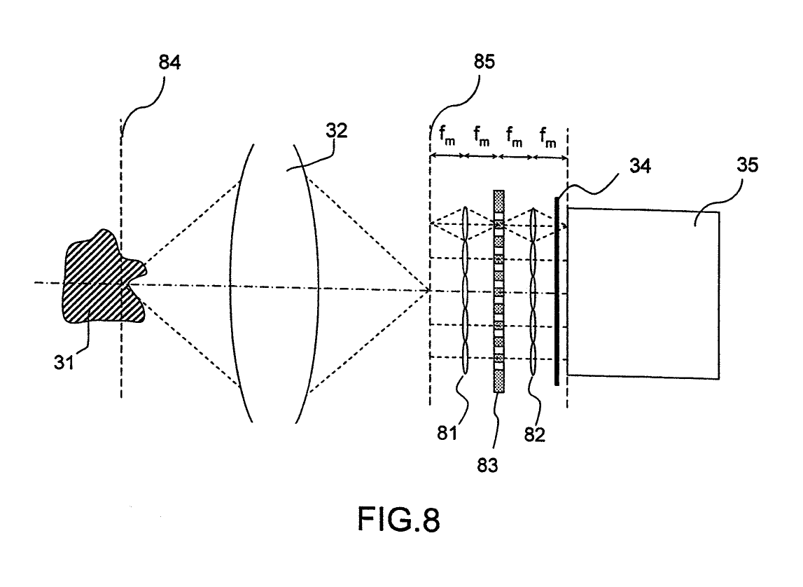

A third variant of a polarimetric imaging system according to the invention is illustrated in FIG. 8. The third variant of a polarimetric imaging system according to the invention comprises: an objective 32 forming a first image of the object 31 in a plane 85. The plane 85 corresponds to the object focal plane of a first micro-lens matrix 81 which ensures the focusing of the light in the plane of a matrix of programmable waveplates 83, at the center of each elementary programmable waveplate of said matrix 83. A second micro-lens matrix 82 reforms the image on the sensor 35. The system furthermore comprises a polarizer 34. This third variant makes it possible to reduce the bulkiness of the system as well as the control voltages.

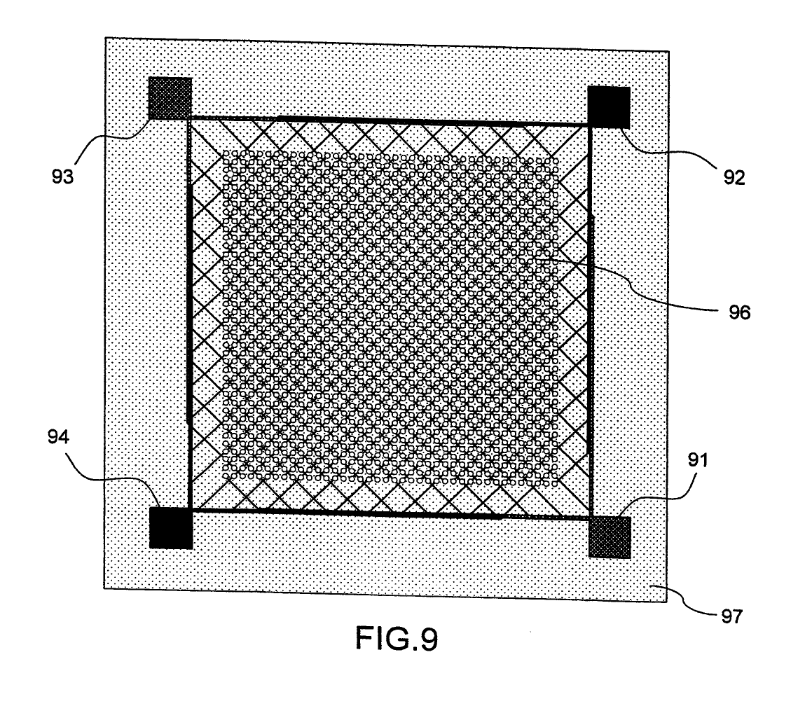

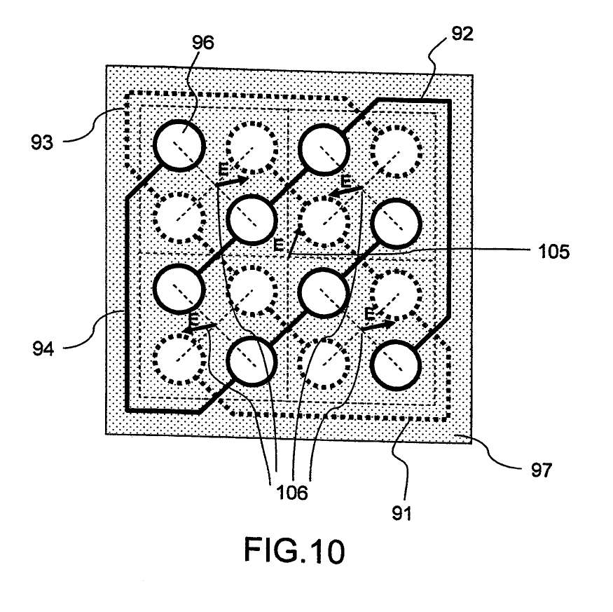

FIGS. 9 and 10 present an exemplary embodiment of a matrix of programmable waveplates 83 used in the third variant of a polarimetric imaging system according to the invention. The matrix 83 comprises electrodes 96 distributed regularly in a matrix manner. The matrix 83 furthermore comprises four contact tracks. A first track 94 and a second track 92 are situated on a first face of the material. A third track 91 and a fourth track 93 are situated on an opposite face from said first face. A pixel 106 is formed by four adjacent electrodes linked by four different tracks.

According to the type of embodiment presented as an example, the pixels of the matrix are controlled collectively, any variation in characteristics from pixel to pixel being correctable on processing by calibration. It is also noted in the example of FIG. 10 that the electric fields generated are opposite for two adjacent pixels. This does not influence the operation of the device since the electrooptic effect used is quadratic, hence independent of the polarity of the electric field. It is also possible to envisage individual addressing of each pixel.

In the third variant of a polarimetric imaging system according to the invention, the number of resolved points in the image reconstituted on the sensor 35 is then n×n×N with n×n the number of pixels of the matrix of programmable waveplates 83 and N the value given by equation (1). With respect to the second variant of a polarimetric imaging system according to the invention, a factor n is therefore gained with regard to the inter-electrode spacing necessary to obtain a given number of resolved points in the image. However, the product n×n is bounded above by the number of pixels of the sensor 35.

According to an exemplary embodiment of the third variant of a polarimetric imaging system according to the invention, for 25×25 elements, 1000×1000 resolved points in the image are obtained for an inter-electrode spacing of 100 microns. Control voltages of the order of 60 Volts are then obtained for a substrate whose electrooptic coefficient is typically of the order of 2.10⁻¹⁶ m²V⁻² and whose thickness e is 500 microns.

Advantageously, the focal length fₘ of the micro-lenses of the first matrix of micro-lenses 81 satisfies the following equation:

$${f}_{m} = \frac{1}{n} \times \frac{\sqrt{A / π}}{{θ}_{lim}}$$

where θₗᵢₘ is the angular acceptance of a programmable waveplate of the matrix 83 and A the surface area defined by the intersection of the cones of vertex half-angle θₗᵢₘ with the plane of the first matrix of micro-lenses 81.

The flux collected on the sensor is proportional to ΩA, Ω being the solid angle defined by the cone of vertex half-angle θₗᵢₘ. The use of a matrix component therefore makes it possible to gain a factor n with regard to the bulkiness of the optical system, for identical flux collected.

Advantageously, the electrooptic material is of ceramic type.

Advantageously, the ceramic is (Pb₁₋ₓLaₓ)(Zr_{y}Ti_{z})_{1-x/4}O₃ (PLZT) or [Pb(Mg_{1/3}Nb_{2/3})O₃]₁₋ₓ[PbTiO₃]ₓ (PMN-PT).

A fourth variant of a polarimetric imaging system according to the invention uses the elements constituting the third variant of a polarimetric imaging system according to the invention, illustrated in FIGS. 8, 9 and 10. In FIG. 10, it is noted that the electrodes of 4 adjacent pixels 106 used for the architecture 3 form at the center of these pixels 106 another pixel 105, for which the electric field generated is symmetric with the field of the other 4 pixels with respect to the diagonal axes. The proposed variant utilizes the central pixel 105 to reduce the number of images necessary for obtaining the system of equations giving the Stokes parameters. Specifically, in this case, an image on the sensor yields 2 equations of the type I(x,y)=f(s₀,s₁,s₂,s₃). Nevertheless, this variant is accompanied by a loss of resolution, since in this case, the information obtained is averaged over each of the pixels, the number of resolved points becoming half the number of pixels of the component.

It will be readily seen by one of ordinary skill in the art that the present invention fulfils all of the objects set forth above. After reading the foregoing specification, one of ordinary skill in the art will be able to affect various changes, substitutions of equivalents and various aspects of the invention as broadly disclosed herein. It is therefore intended that the protection granted hereon be limited only by definition contained in the appended claims and equivalents thereof.

1. A polarimetric imaging system exhibiting an optical axis, and comprising means: for the detection and analysis of the light backscattered by an object illuminated by a light source and at least one programmable waveplate,
a set of two matrices of micro-lenses making it possible to define an intermediate second focal plane,
a matrix of programmable waveplates, situated in said second intermediate focal plane, the programmable waveplates comprising a material with an isotropic electrooptic tensor and a set of at least three electrodes disposed along the directions parallel to the optical axis of the imaging system.

2. The polarimetric imaging system as claimed in claim 1, wherein the electrodes are formed of substantially cylindrical and metallized emergent holes in the thickness of the material with an isotropic electrooptic tensor.

3. The polarimetric imaging system as claimed in claim 1, wherein the matrix of programmable waveplates comprises a matrix of electrodes, four contact tracks so as to contact all the electrodes, a first and a second track being situated on a first face of the material, a third and a fourth track being situated on an opposite face from said first face, said electrodes exhibiting coordinates referenced by a row number j and a column number k which are integers in a reference frame corresponding to the plane of the matrix, said first track linking the electrodes whose coordinates (j,k) satisfy the following equation:
k=4p₁−j, where p₁ is a relative integer,
said second track linking the electrodes whose coordinates (j,k) satisfy the following equation:
k=(4p₂+2)−j, with p₂ relative integer,
said third track linking the electrodes whose coordinates (j,k) satisfy the following equation:
k=(4p₃₊₁)+j, with p₃ relative integer,
said fourth track linking the electrodes whose coordinates (j,k) satisfy the following equation:
k=(4p₄+3)+j, with p₄ relative integer.

4. The polarimetric imaging system as claimed in claim 1, wherein the focal length (fₘ) of the micro-lenses of the first matrix of micro-lenses satisfies the following equation:
$${f}_{m} = \frac{1}{n} \times \frac{\sqrt{A / π}}{{θ}_{lim}}$$
where θₗᵢₘ is the angular acceptance of a programmable waveplate of the matrix and A the surface area defined by the intersection of the cones of vertex half-angle θₗᵢₘ with the plane of the first matrix of micro-lenses.

5. The polarimetric imaging system as claimed in claim 1, wherein the electrooptic material is of ceramic type.

6. The polarimetric imaging system as claimed in claim 5, wherein the ceramic is (Pb₁₋ₓLaₓ)(Zr_{y}Ti_{z})_{1-x/4}O₃ (PLZT) or [Pb(Mg_{1/3}Nb_{2/3})O₃]₁₋ₓ[PbTiO₃]ₓ (PMN-PT).

7. The polarimetric imaging system as claimed in claim 1, wherein the detection and analysis means comprise the measurement of the components s_{0,in}, s_{1,in}, s_{2,in} and s_{3,in} of a Stokes vector of the light backscattered by the object, said measurement comprising:
a series of N sets of three steps, allowing N intensity measurements, said steps being, with 1≦j≦N:
the choice of a birefringence ∈ⱼ of the waveplate and of an orientation θⱼ of this birefringence with respect to a predefined axis.
the determination of the potentials Vᵢ to be applied to the electrodes Eᵢ so as to obtain the birefringence ∈ⱼ of orientation θⱼ determined in the previous step, said potentials Vᵢ satisfying the following equations:
$${V}_{i} = \frac{1}{2} \sqrt{\frac{λ {d}^{2} {ɛ}_{j}}{π {n}_{0}^{3} R e}} cos ( {θ}_{j} - i \frac{π}{2} )$$
with i an integer lying between 0 and 3, λ the wavelength, n₀ the index of the material at zero field, R the quadratic electrooptic coefficient, e the thickness of the material and d the distance between 2 facing electrodes.
